(19) United States
(12) Patent Application Publication
(10) Pub. No.: US 2011/0051967 A1
(43) Pub. Date: Mar. 3, 2011

(54) HEARING AID WITH PROTECTION AGAINST UNINTENTIONAL OPERATION

(75) Inventors: Meng Kiang Lim, Singapore (SG); Rubab Shahbaz Khan, Singapore (SG)

(73) Assignee: SIEMENS MEDICAL INSTRUMENTS PTE. LTD., Singapore (SG)

(21) Appl. No.: 12/851,055

(22) Filed: Aug. 5, 2010

(30) Foreign Application Priority Data
Aug. 5, 2009 (DE) 10 2009 036 236.3

(51) Int. Cl. H04R 25/00

(52) U.S. Cl. 381/322

(57) ABSTRACT

A hearing aid has protection against unintentional operation. The protection against unintentional operation is provided for the purpose of suppressing erroneous, mistaken or unintentional user inputs for changing settings of a hearing aid. The hearing aid contains signal-processing electronics arranged in a housing and an operating element actuated manually, arranged externally on the housing. A locking arrangement is configured to lock the operating element in respect of manual actuation, and an unlocking arrangement is configured to deactivate the locking arrangement. The unlocking arrangement contains at least two sensors actuated manually, which are arranged spatially separate from one another on the housing. The unlocking arrangement deactivates the locking arrangement only during and/or in a limited time period following simultaneous manual actuation of the sensors. The spatially separate arrangement of the sensors can suppress an accidental undesired actuation.

### CROSS-REFERENCE TO RELATED APPLICATION

This application claims the priority, under 35 U.S.C. §119, of German application DE 10 2009 036 236.3, filed Aug. 5, 2009; the prior application is herewith incorporated by reference in its entirety.

### BACKGROUND OF THE INVENTION

### Field of the Invention

The invention relates to a hearing aid with protection against unintentional operation. Protection against unintentional operation is provided for the purpose of suppressing erroneous, mistaken or unintentional user inputs for changing settings of a hearing aid. Such unintentional operation can easily occur during routine handling of the hearing aid and during use, for example by accidentally actuating the on/off switch or adjusting the volume controller. In particular, unintentional operations can occur in pediatric hearing aids, for example if the child wearing the hearing aid does not yet understand the function or operation of the latter. This is critical in the case of infants because an inadvertently increased volume can lead to additional hearing damages; however, the infant is generally unable to correct the volume settings or communicate the erroneous settings.

By way of example, it is known to adjust the hearing aid exclusively by a remote control and deactivate possible manual operating elements on the hearing aid housing as protection against unintentional operation for pediatric hearing aids; this is also referred to as a child-proof lock. The remote control remains with the parents or the supervisor while the child can undertake no adjustments on the hearing aid.

German utility model DE 299 16 350 U1 discloses a hearing aid that is switched on and off by opening the battery compartment. In this hearing aid, the battery compartment can be closed, wherein the instrument is then switched on, opened, wherein the instrument is then switched off but the battery cannot be removed, or folded out, wherein the battery can then be removed. An adjustable locking element is provided on the battery compartment mechanism and it can lock both an opening of the battery compartment and the folding out thereof. The locking element cannot be operated just like that by a child and therefore constitutes a child-proof lock. However, the actuation of a locking element as known previously can also be difficult for elderly hearing-aid wearers, particularly if vision and abilities of coordination are dwindling due to advanced age.

### SUMMARY OF THE INVENTION

It is accordingly an object of the invention to provide a hearing aid with protection against unintentional operation which overcomes the above-mentioned disadvantages of the prior art devices of this general type. The invention is based on the object of developing protection against unintentional operation of a hearing aid, which protection is first simple to operate and places no increased requirements on vision or abilities of coordination, but which second cannot undesirably be unlocked inadvertently or by chance by a child or an infant. Additionally, it should be possible to unlock the protection against unintentional operation without additional tools and also without a remote control.

A basic idea of the invention consists of a hearing aid containing a housing, signal-processing electronics arranged therein, and an operating element to be actuated manually, arranged externally on the housing. A locking arrangement is provided and is configured to lock the operating element in respect of manual actuation. An unlocking arrangement is provided which is configured to deactivate the locking arrangement. The unlocking arrangement includes at least two sensors to be actuated manually, which are arranged spatially separate from one another on the housing, and the unlocking arrangement deactivates the locking arrangement only during and/or in a limited time period following simultaneous manual actuation of the sensors.

The spatially separate arrangement of the at least two sensors ensures that an accidental undesired actuation can be suppressed. An expedient arrangement of the sensors would avoid those places on the housing of the hearing aid where the hearing aid is gripped or held in routine handling. Furthermore, it is also possible to leave out places on the housing onto which the hearing aid is typically placed, or which typically rest against the ear or skull when the hearing aid is worn. The sensors can be arranged ergonomically matched to the shape of a human hand or the fingers, and so simultaneous actuation does not have to occur inadvertently, but is eased for the operator or the hearing-aid wearer. It is clear that an increased number of sensors ensure a higher degree of protection against unintentional operation because the simultaneous actuation is more complex and hence an inadvertent undesired actuation becomes less likely, but that at the same time this has an adverse effect on the operability.

The unlocking arrangement can be configured to unlock the locking arrangement not only during an actuation, but also during a limited time period following the actuation. This allows the operation of the hearing aid for changing settings by the initial actuation, but the actuation does not have to be maintained during further adjustment steps, and this simplifies setting changes, particularly in the case of a complex arrangement of the sensors of the unlocking arrangement. Thus, for example, during a certain period of time after actuating the unlocking arrangement, during which the unlocking arrangement no longer has to be actuated, as a result of which undesired interference is also no longer generated, the hearing aid can be adjusted to the respective surroundings in respect of the volume settings. The temporally limited unlocking can expediently be limited to a time period of between two and twenty seconds.

As per an advantageous development of the basic idea, the locking arrangement locks the operating element mechanically.

A mechanical lock can, on the one hand, be implemented without much complexity and operate with a high reliability. On the other hand, it is independent of a voltage supply and uses no energy. As a result of this, the service life of the battery of the hearing aid is not reduced. In addition, a mechanical lock of operating elements can be felt when an attempt is made to actuate the latter. This tactile feedback shows the operator or the hearing-aid wearer that the locking arrangement for locking the operating element or elements has been activated.

As per a further advantageous development, the locking arrangement is configured to lock the operating element electronically.

As per a further advantageous development, the unlocking arrangement is configured to deactivate the locking arrangement electronically, and the sensors are configured as electronic sensors, for example as pressure sensors, heat sensors, capacitive, inductive, resistive or optical sensors.

An electronic unlocking arrangement with electronic sensors can be implemented in a cost-effective and uncomplicated fashion. In the case of software-controlled hearing aids, it is merely the sensors that are provided additionally, while the locking/unlocking functionality can be programmed in its entirety by software. This keeps the device complexity down. Additionally, provision can be made for sensors that respond to typical properties of the human body of an operator or a hearing-aid wearer, for example heat or conductivity of the skin, and so inadvertent chance actuations by other influences, e.g. when the hearing aid is being stored or transported, can be suppressed.

Other features which are considered as characteristic for the invention are set forth in the appended claims.

Although the invention is illustrated and described herein as embodied in a hearing aid with protection against unintentional operation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a hearing aid with protection against unintentional operation according to the invention;

FIG. 2 is a front view of the hearing aid;

FIG. 3 is a side view of the hearing aid;

FIG. 4 is a perspective view for showing an actuation of the unlocking arrangement by a human hand;

FIG. 5 is a side view of the hearing aid with protection against unintentional operation;

FIG. 6 is a front view of the hearing aid with protection against unintentional operation;

FIG. 7 is a side view of the hearing aid with protection against unintentional operation;

FIG. 8 is a side view of a second embodiment of the hearing aid with protection against unintentional operation;

FIG. 9 is a front view of the second embodiment of the hearing aid with protection against unintentional operation;

FIG. 10 is a side view of the second embodiment hearing aid with protection against unintentional operation; and

FIG. 11 is an illustration of the hearing aid with a mechanical locking arrangement.

### DETAILED DESCRIPTION OF THE INVENTION

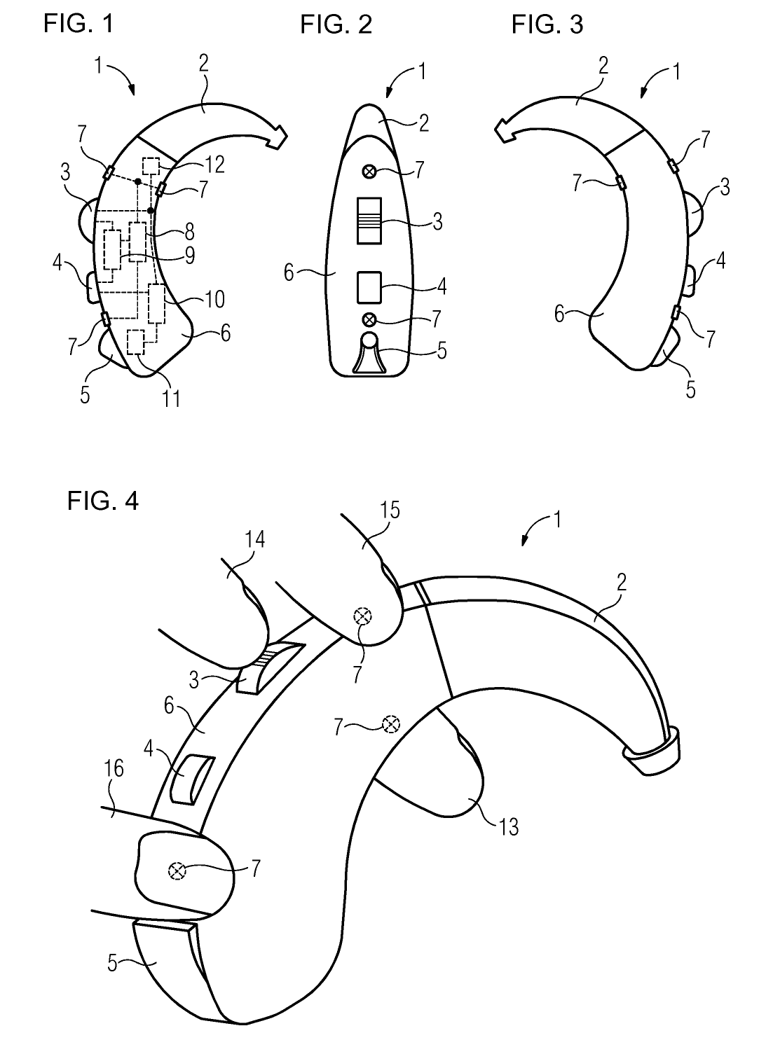

Referring now to the figures of the drawing in detail and first, particularly, to FIG. 1 thereof, there is shown a hearing aid 1 with protection against unintentional operation. The hearing aid is configured as a behind-the-ear (BTE) instrument. It contains a tone hook 2, by which it can be hooked onto or behind the human ear. Further embodiment variants can contain other housing shapes, for example in-the-ear (ITE) instruments or completely-in-canal (CIC) instruments.

The hearing aid 1 contains a housing 6 in which the electrical components are arranged. A signal-processing arrangement 10 receives input signals from a microphone 11, which records acoustic surrounding sounds and converts them into electrical signals. Depending on the hearing program, the signal-processing arrangement 10 processes these input signals such that they are matched to the individual hearing disorder of the hearing-aid wearer and amplifies the input signals where necessary. The output signals of the signal-processing arrangement are transmitted to a loudspeaker 12, usually referred to as a receiver, which converts these into acoustic output signals. The acoustic output signals of the receiver 12 are transmitted to the ear of the hearing-aid wearer through the tone hook 2, wherein a sound tube, not illustrated in the figure but arranged between the tone hook 2 and the auditory canal, is used for the targeted transmission of the acoustic signals.

A volume adjuster 3 that can be actuated manually is arranged on the housing 6. Actuating the volume adjuster 3 adjusts the volume level of the output signals of the receiver 12. This adjustment is undertaken independently of the processing of the acoustic input signals in the signal-processing arrangement 10 and can for example be used for matching in respect of modified sound surroundings. Moreover, an on/off switch 4 is arranged on the housing 6. The hearing aid 1 can be switched on or off by actuating the on/off switch 4.

A battery compartment 5 holds a battery (not illustrated) for supplying the hearing aid 1 with voltage. The battery compartment can be folded open or can be folded out, for which purpose it can be gripped by the lug or protrusion visible in the figure. Opening the battery compartment 5 interrupts the voltage supply and so the hearing aid is necessarily switched off. Additionally, access to the battery is cleared, which battery can be removed from the hearing aid 1 or the battery compartment 5 if necessary. In pediatric hearing aids in particular, unintended removal of the battery constitutes a problem to the extent that a child could easily swallow the very small battery. It is therefore desirable, particularly in the case of pediatric hearing aids, to also be able to lock shut an opening of the battery compartment 5 by protection against unintentional operation or a child-proof lock. Such a lock can be affected in a purely mechanical fashion by a bolt, or it can be implemented by an electronically-driven bolt, e.g. a magnetic lock.

The operating elements of the hearing aid 1—the volume controller 3 and the on/off switch are illustrated in the figure—can be locked by a locking arrangement 9. The locking arrangement 9 prevents manual actuation from being able to lead to a change in the volume setting or to the hearing aid 1 being switched off. To this end, it is possible, for example, to bridge the on/off switch 4, which interrupts or establishes an electrical line to the voltage supply. The by-passing can prevent the voltage supply from being interrupted when the switch is actuated. In respect of the voltage adjuster 3, the locking arrangement 9 can suppress even the generation of the signal impulses generated by the volume adjuster 3 in the case of manual actuation and emitted to the signal-processing arrangement 10. By way of example, an electrical supply line to the volume adjuster 3 can be interrupted by the locking arrangement 9 for this purpose. Or the output signals of the volume adjuster 3, which are transmitted to the signal-processing arrangement 10, are suppressed by interrupting a line. Further embodiment variants for locking the volume adjuster 3 by the locking arrangement 9 are likewise possible, for example the implementation in only the equipment software.

The locking arrangement 9 can be deactivated by an unlocking arrangement 8. Here, deactivation means that the lock on the operating elements by the locking arrangement 9 is lifted, that is to say deactivated. The unlocking arrangement 8 is triggered by manual actuation by an operator or the hearing-aid wearer. Here, the manual actuation is brought about by sensors 7 arranged on the housing 6. The sensors 7 are configured such that they register actuation by sensor means. By way of example, they can respond to pressure or heat, to capacitive or inductive influences typical for the approach of a human finger, or to resistive influences when touched by a human finger due to the conductivity of the human skin. A multiplicity of mechanical and electronic sensors can be used as the sensors 7. When selecting the suitable sensor principle, low spatial requirements and low energy requirements in particular play an important role. In this respect, simple pressure buttons for example can be considered advantageous. Other sensors can possibly convey higher operating comfort or higher operating reliability.

The sensors 7 are connected to the unlocking arrangement 8. The unlocking arrangement 8 is configured such that it only deactivates the locking arrangement 9 when at least two sensors 7 are actuated. An even higher protection against unintentional operation is achieved if the unlocking arrangement 8 only responds when all three sensors 7 are actuated. Here, the number of sensors 7 that have to be actuated for the unlocking can be programmable or fixedly prescribed. The sensors 7 are arranged with spatial separation and so simultaneous actuation due to being touched by a single finger is impossible. This suppresses chance inadvertent actuations. Furthermore, the sensors 7 are arranged on the housing 6 such that they are not inevitably actuated through contact with the ear or skull when the hearing aid 1 is worn behind the ear. Moreover, the arrangement of the sensors 7 can be configured such that it is ergonomically matched to a human hand and thus simplifies the operation.

In a wired variant (not illustrated), the sensors 7 in each case actuate a switch, transistor, or relay or comparable switching device. These are connected in series and so the series connection overall is conductive or signal-carrying only once all sensors 7 are actuated. The series connection is arranged directly in a supply line of the volume adjuster 3 or the on/off switch 4, and so the respective operating element is only unlocked or activated once all sensors are actuated. A further variant consists of the series connection being arranged in the output line of the respective operating element. The series connection then forms the main component of the locking arrangement 9, the wired components for actuating the switching elements arranged in series form the main component of the unlocking arrangement 8.

In a further variant, the signals from the sensors 7 are transmitted to an unlocking arrangement 8 in series or in parallel and are combined there. For this, a series connection of switching elements is used as described above, or the signals are AND-linked by wires or software. The unlocking arrangement 8 transmits the signal AND-linked in this fashion to the locking arrangement 9. The locking arrangement 9 locks the volume adjuster 3 or the on/off switch 4 in the normal state, but unlocks these if deactivated by the output signal of the unlocking arrangement 8. For this purpose, a provision is made in the locking arrangement 9 for a switch, transistor, relay or other switching element, which interrupts either the supply or the signal output of the respective operating element or which closes the former when deactivated by the signal from the unlocking arrangement 8.

FIG. 2 illustrates the hearing aid 1 described above from a different view while maintaining the same reference signs. The reproduction of electronic elements arranged in the housing 6 and indicated by dashed lines above was foregone. It can be seen that the sensors 7 are arranged centrally in the housing 6 on the side of the hearing aid 1 facing the observer. The additional sensor on the opposite housing side cannot be seen in the selected perspective.

FIG. 3 illustrates the hearing aid 1 described above in a further side view. The illustration appears mirror-inverted with respect to the illustration selected above in FIG. 1. The mirror-symmetrical configuration of the hearing aid housing or the arrangement of the sensors 7 and the other operating elements allows the use of the housing configuration for both left-hand and right-hand hearing aids.

FIG. 4 indicates how the protection against unintentional operation has to be operated. The above-described hearing aid is illustrated in a further perspective view while using the same reference signs. The sensors 7, indicated by dashed lines in the FIG. 4, are actuated simultaneously by the indicated fingers on a hand, wherein the thumb 13 actuates the single sensor 7 on one side of the housing 6, while middle finger 15 and ring finger 16 actuate the two sensors 7 on the opposite housing side. The index finger 14 can be used to adjust the now unlocked operating element—the volume adjuster 3 in the illustration—when the sensors 7 are actuated simultaneously in this fashion.

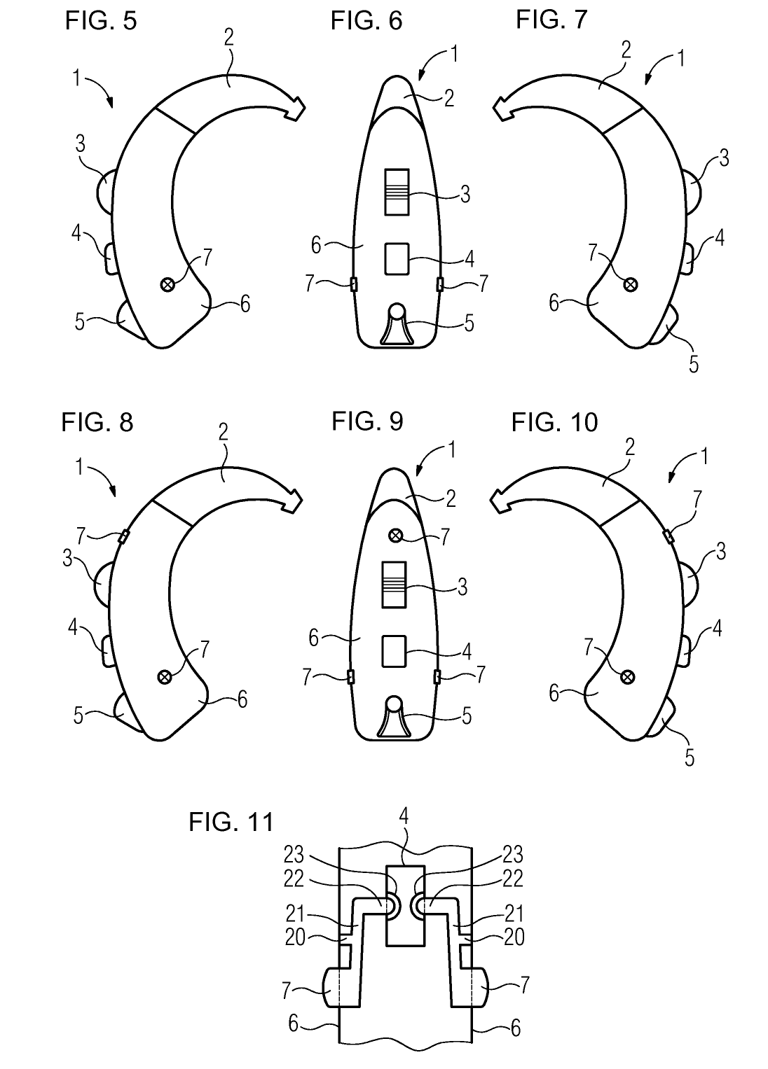

FIG. 5 illustrates a hearing aid 1 comparable to the one explained above, which merely differs in the arrangement of the sensors 7. The sensor 7 is arranged on the flat side of the housing 6. No additional sensor can be seen in the selected perspective.

FIG. 6 illustrates the same hearing aid 1 in a different perspective. It can be seen that the sensors 7 are arranged at the same position on opposing sides of the housing 6.

FIG. 7 illustrates the same hearing aid 1 in a further perspective. The sensor 7 is arranged on the opposite side of the housing 6 on the same location as the sensor 7 visible in FIG. 5 above. In such an arrangement of the sensors 7, the hearing aid can, for example, be gripped with the thumb and the middle finger in the region of the sensors 7 for unlocking the operating elements such that thumb and middle finger each actuate one sensor 7 and thereby unlock the volume adjuster 3 or the on/off switch 4. In addition, it is also possible to provide for a lock for the battery compartment 5 against inadvertent or unwanted opening. The selected arrangement of the sensors 7 in the direct vicinity of the battery compartment 5 would be suitable for a mechanical configuration of the locking arrangement or the unlocking arrangement in a particularly advantageous fashion, as explained in more detail below.

FIGS. 8-10 illustrate a further variant of the above-described hearing aid 1 with a once-again modified arrangement of the sensors 7. Two sensors 7 are arranged on opposite sides of the housing 6 and a further sensor 7, visible in FIG. 9, is arranged on the narrower housing side oriented perpendicular thereto. This variant is symmetrical, like the variants illustrated above, and so it can be used in both left-hand and right-hand hearing aids. Further variants with other arrangements of the sensors 7, which can be both symmetric and asymmetric, are possible and these e.g. further improve the operation ergonomics or further increase the protection against unintentional operation.

FIG. 11 schematically illustrates a purely mechanical variant of the locking arrangement and unlocking arrangement. The figure shows a cross section through the housing 6. An on/off switch 4 is arranged centrally. The switch 4 has lateral recesses 23 on both sides. The bolts 22 engage in the lateral recesses 23. The bolts 22 prevent actuation of the switch 4 being possible by mechanically suppressing a movement of the switch. They therefore form the locking arrangement. The bolts 22 are each arranged on tilt levers 21, which in turn are respectively mounted in a tilting bearing 20. Each tilt lever 21 can be tipped about its tilting bearing 20. The configuration of the tilting bearing has not been illustrated in any more detail; by way of example, a flexible plastic connection to the housing 6 can be used. In any case, it must be configured such that the bolts 22 engage in the recesses 23 of the switch in the non-actuated state. This ensures that the switch 4 is locked as long as the sensors 7 have not been actuated. When the sensors 7 are actuated by pressure, the tilt levers 21 tilt about the tilting bearings 20. This pulls the bolts 22 out of the recesses 23. It can be seen that actuation of the switch 4 is only unlocked when both sensors 7 are actuated simultaneously.

Further mechanical embodiments are possible, which can for example serve for locking a volume adjuster or a battery compartment.

A basic idea of the invention can be summarized as follows: the invention relates to a hearing aid with protection against unintentional operation. Protection against unintentional operation is provided for the purpose of suppressing erroneous, mistaken or unintentional user inputs for changing settings of a hearing aid. According to a basic idea of the invention, the hearing aid 1 contains a housing 6, signal-processing electronics 10 arranged therein, and an operating element 3, 4, 5 to be actuated manually, arranged externally on the housing 6. Additionally, a locking arrangement 9 is provided, which is configured to lock the operating element 3, 4, 5 in respect of manual actuation, and an unlocking arrangement 8, which is configured to deactivate the locking arrangement 9. The unlocking arrangement 8 contains at least two sensors 7 to be actuated manually, which are arranged spatially separate from one another on the housing 6. The unlocking arrangement 8 deactivates the locking arrangement 9 only during and/or in a limited time period following simultaneous manual actuation of the sensors 7. The spatially separate arrangement of the sensors can suppress an accidental undesired actuation. An expedient arrangement of the sensors would avoid places on the housing where the hearing aid is gripped or held in routine handling, onto which the hearing aid is placed, or which typically rest against the ear or skull when worn. The sensors can be arranged ergonomically matched to the shape of a human hand or the fingers.

1. A hearing aid, comprising:
a housing;
signal-processing electronics disposed in said housing;
an operating element to be actuated manually, disposed externally on said housing;
a locking configuration configured to lock said operating element in respect of manual actuation; and
an unlocking configuration configured to deactivate said locking configuration, said unlocking configuration having at least two sensors to be actuated manually, which are disposed spatially separate from one another on said housing, and said unlocking configuration deactivates said locking configuration one of only during simultaneous manual actuation of said sensors and during simultaneous manual actuation of said sensors and during a limited time period following the actuation of said sensors.

2. The hearing aid according to claim 1, wherein said locking configuration locks said operating element mechanically.

3. The hearing aid according to claim 2, wherein said unlocking configuration deactivates said locking configuration mechanically, and said sensors are actuated manually by one of pressing, sliding and tipping.

4. The hearing aid according to claim 1, wherein said locking configuration locks said operating element electronically.

5. The hearing aid according to claim 4, wherein said unlocking configuration deactivates said locking configuration electronically, and said sensors are electronic sensors.

6. The hearing aid according to claim 5, wherein said sensors are selected from the group consisting of pressure sensors, heat sensors, capacitive sensors, inductive sensors, resistive sensors and optical sensors.

7. The hearing aid according to claim 1, wherein said operating element is selected from the group consisting of on/off switches and volume controllers.
